(19) United States
(12) Patent Application Publication
(10) Pub. No.: US 2008/0135495 A1
(43) Pub. Date: Jun. 12, 2008

(54) System And Method For Producing Water

(75) Inventor: Abraham M. Sher, Miami Beach, FL (US)

Correspondence Address: BROOKS KUSHMAN P.C., 1000 TOWN CENTER, TWENTY-SECOND FLOOR, SOUTHFIELD, MI, 48075, US

(73) Assignee: AQUA SCIENCES, INC., Miami Beach, FL (US)

(21) Appl. No.: 11/574,164

(22) PCT Filed: Aug. 26, 2005
(86) PCT No.: PCT/US05/30529

§ 371 Date: Jul. 16, 2007

Related U.S. Application Data
(60) Provisional application No. 60/606,326, filed on Aug. 31, 2004.
(60) Provisional application No. 60/619,264, filed on Oct. 15, 2004.
(60) Provisional application No. 60/642,597, filed on Jan. 10, 2005.

(51) Int. Cl. E03B 3/28; B01D 53/14; C02F 1/32

(52) U.S. Cl. 210/748; 95/117; 261/5

(57) ABSTRACT

A method for producing water includes removing water from a first airflow using a first process which includes exposing at least some of the first airflow to a desiccant. This increases water content of at least some of the desiccant. At least some of the desiccant having increased water content is introduced into a second airflow. This facilitates evaporation of water from the desiccant into the second airflow, and increases water content of the second airflow. Water is then removed from the second airflow.

### CROSS-REFERENCE TO RELATED APPLICATIONS

This application claims the benefit of U.S. provisional application Ser. No. 60/606,326 filed Aug. 31, 2004; U.S. provisional application Ser. No. 60/619,264 filed Oct. 15, 2004; and U.S. provision application Ser. No. 60/642,597, filed Jan. 10, 2005, each of which is hereby incorporated herein by reference.

### BACKGROUND OF THE INVENTION

1. Field of the Invention

The present invention relates to a system and method for producing water.

2. Background Art

Conventionally, water is collected from air using condensation systems. An exemplary condensation system provides a surface cooled to a temperature that is at or below the dew point of incoming air. As is well known in the art, the cooling of air at or below its dew point causes the condensation of water vapor from the air and a decrease in the absolute humidity of the air. The humidity of a volume of air is substantially determinative of the amount of water that can be introduced into, or removed from, the volume of air.

Existing water generation systems collect water vapor from incoming airflows using conventional condensation systems that lower the temperature of incoming air to a temperature that is at or below the dew point of the air. Therefore, the quantity of water produced by such systems depends on the humidity of the ambient air. The humidity and temperature of air varies, however, from region to region, with hot and humid air in tropical and semi-tropical regions, and cooler, less humid air in other parts of the world. The temperature and water vapor content of air also varies widely with seasonal weather changes in regions throughout the year.

As a result it has been found that the water dispensing capability of prior art air-to-water generating systems is severely impaired in regions and seasons of low humidity. Conventional machines only produce enough water when the humidity is above a certain threshold percentage. This is too high a humidity level for climate controlled buildings, thereby rendering the machines less useful for most commercial and residential purposes and in certain portions of the world where the humidity level is low.

Therefore, there is a need for a system and method for producing water even when the humidity and dew point of ambient air are low.

### SUMMARY OF THE INVENTION

The present invention provides a system and method for producing water even when the humidity and dew point of ambient air are low.

The invention also provides a method for producing water that includes removing water from a first airflow using a first process which includes exposing at least some of the first airflow to a desiccant. This increases the water content of at least some of the desiccant. At least some of the desiccant having increased water content is introduced into a second airflow, thereby facilitating evaporation of water from the desiccant into the second airflow. This also increases water content of the second airflow. Water is then removed from the second airflow after its water content is increased.

The invention further provides a method for producing water using a system including first and second chambers and a heat exchanger. The method includes passing a first airflow through the first chamber. At least some of the first airflow is exposed to a desiccant in the first chamber. This removes water from the first airflow and increases water content of the desiccant. At least some of the desiccant having increased water content is introduced into the second chamber. A second airflow is passed through the second chamber to facilitate evaporation of water from the desiccant into the second airflow. The second airflow is passed through the heat exchanger after its water content is increased. This facilitates cooling of second airflow and condensation of the water therefrom.

The invention also provides a system for producing water that includes a first chamber having an inlet and an outlet for facilitating movement of a first airflow into and out of the first chamber. The system also includes a desiccant capable of being introduced into the first chamber for removing water from the first airflow moving through the first chamber. A second chamber is configured to receive at least a portion of the desiccant after it removes water from the first airflow. The second chamber includes an inlet and an outlet for facilitating movement of a second airflow into and out of the second chamber. This facilitates evaporation of water from the desiccant in the second chamber into the second airflow. A system heat exchanger is configured to receive the second airflow from the second chamber and to facilitate cooling of the second airflow to extract water therefrom.

The present invention further provides a system for extracting water from air. This system includes a desiccant collection chamber wherein a solid desiccant or desiccant solution is exposed to physical contact with a first air stream, and wherein diluted desiccant is produced. Also provided is a desiccant regeneration chamber. The desiccant is warmed and introduced into the second chamber. There, the desiccant is exposed to physical contact with a second air stream, wherein humid air is produced. The humid air stream is placed in physical contact with a condenser so that water vapor is condensed from the humid air stream.

The present invention also provides a system and method for passing ambient air into a first chamber having a suitable desiccant material therein. The desiccant absorbs or adsorbs moisture from the air that comes in contact with the desiccant. In one embodiment, the air contacts desiccant by pumping air through a contact surface, such as a sponge, media, cooling coil, or cooling tower, that has desiccant dispersed therein. The desiccant and/or first chamber may be cooled to enable the more efficient transfer of water from the air to the desiccant. The desiccant absorbs or adsorbs water from the air, thereby transferring latent heat from the air as the water undergoes a phase change and condenses out of the air. Because the desiccant and/or first chamber are cooled, sensible cooling—i.e., cooling that is not based on a change of state—is also provided to the air. The resulting dry, cooled air is drawn out from the first chamber.

The now hydrous desiccant collects at the bottom of the first chamber and gets transferred to a second chamber. The second chamber transfer occurs either through active pumping or diffusion via a valve opening provided in a partition between the first and the second chambers. The valve opening enables equalization of desiccant levels in the first and the second chamber. The net flow of hydrous desiccant occurs from the first chamber to the second chamber until the level of the desiccant equalizes in the two chambers. The diffused or pumped hydrous desiccant in the second chamber can be heated and then again exposed to air. In one embodiment, the desiccant is sprayed into the interior of the second chamber. A heat exchanger such as a heating element warms the spray of hydrous desiccant falling from the nozzles, thereby evaporating moisture absorbed or adsorbed into the desiccant, generating hot humid air, and also regenerating substantially anhydrous desiccant.

The desiccant can be introduced into the chambers by any method effective to achieve the desired result. For example, the first chamber may include spongy cellulose material through which the hydrated desiccant percolates down to collect at the bottom of the chamber. Alternatively, the desiccant is made to simply drip in the form of drops from points within, such as the top of, the first and second chambers.

The present invention can also utilize the temperature differential between the dry air coming out of the first chamber and the hotter and humid air manufactured in the second chamber, to effect transference of thermal energy between the two air streams without bringing them into physical contact with each other. For example, a heat exchanger, such as a radiator-type exchanger comprising a plurality of tubing or pipes, can be used to bring two air streams into thermal contact. The hotter and more humid air from the second chamber can be passed through the radiator, while the relatively cool, dry air contacts the outer surfaces of the radiator via a duct that draws in the dry air from the first chamber. This results in condensation of water vapor in the heat exchanger into liquid water that drips down to collect in a condensate collector. Alternatively, the hot humid air can be directed to contact the dew-forming surfaces of a heat absorber, such as an evaporator, that are cooled using a suitable cooling process such as classic boiling fluids contained in tubes, thermoelectric elements, heat pipes, refrigerant-expansion coils or any other system known to persons of ordinary skill in the art.

At least one embodiment of the present invention can sterilize and filter the condensed water to generate pure drinking water. Accordingly, in one embodiment, condensed water from the condensate collector is exposed to suitable ultra-violet (UV) radiation in a UV unit to free the water from harmful microscopic organisms. Additionally, the radiated water is serially passed through a charcoal filter to remove contaminants and Volatile Organic Compounds (VOC's) and a plurality of mineral cartridges to mineralize and/or vitaminize the water. The purified and mineralized water is collected in a first storage tank. Additionally, the water is passed through an oxygenator before being stored in the first storage tank. Water from the first storage tank is recirculated through the UV unit at predetermined intervals of time to maintain quality of water.

At least one embodiment of the present invention can also dispense hot and cold water. Thus, in one embodiment, water from the first storage tank is gravity fed into a second cold storage tank from where it is further gravity fed into a third hot storage tank. Water in the second storage tank is chilled using a suitable cooling process such as Peltier-effect or chemical/magnetic cooling, by the use of a typical expansion-evaporation coils, or by any other method effective to achieve the desired result. The cold water is then dispensed through a first childproof spigot. Also, water in the third tank is heated to a desired temperature by a heating element and dispensed through a second spigot. Ambient temperature water is dispensed from the second spigot when power is disallowed to the heating element of the third tank. In another embodiment, water from the first storage tank can be directly dispensed through a third spigot to provide water at ambient temperature.

The present invention may also be configured to provide for the introduction of water from external sources in the event of low condensate formation. Accordingly, an external source such as a municipal supply faucet is attached through quick-disconnect fittings to supply supplemental water to the first storage tank.

### BRIEF DESCRIPTION OF THE DRAWINGS

FIG. 1 is a simplified schematic representation of a water producing system in accordance with the present invention;

FIG. 2 is a schematic drawing showing a portion of the system shown in FIG. 1; and

FIG. 3 is a schematic drawing showing another portion of the system shown in FIG. 1.

### DETAILED DESCRIPTION OF THE PREFERRED EMBODIMENT(S)

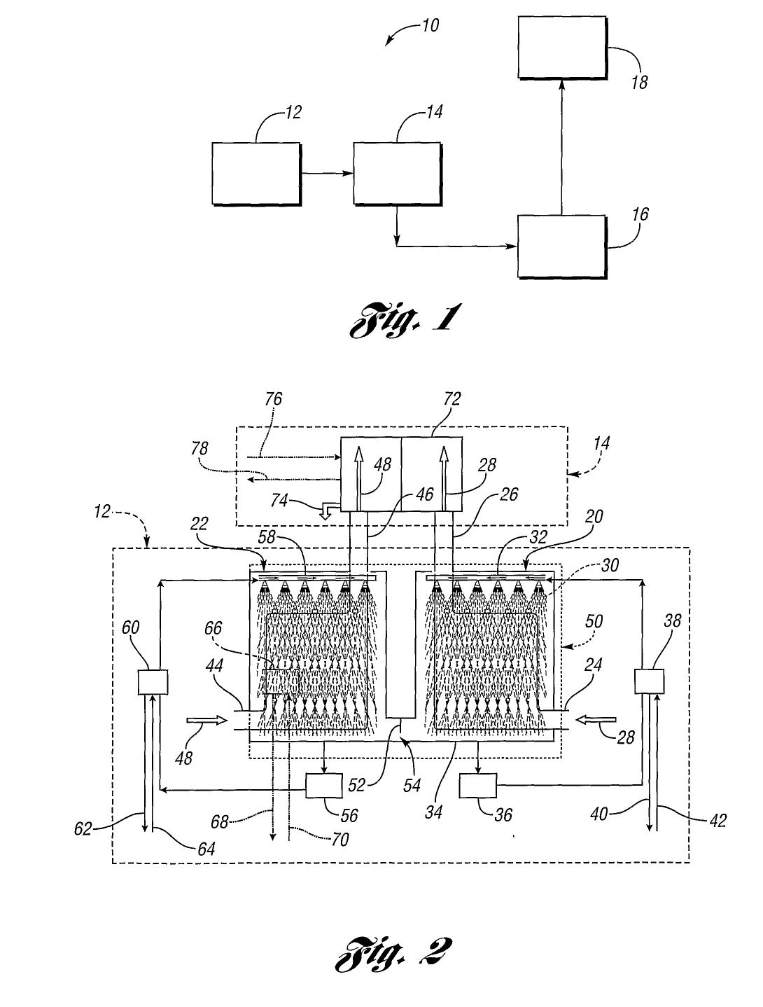

FIG. 1 shows a simplified schematic diagram of a water producing system 10 in accordance with one embodiment of the present invention. The system 10 includes a humid air manufacturing stage 12, a water extraction stage 14, a water purification and filtration stage 16, and a water dispensing stage 18. As described in more detail below, the humid air manufacturing stage 12 includes processes for removing moisture from an ambient air mass, and transferring it into another air mass by use of a desiccant material. The moisture collected in the desiccant material is evaporated into the second air mass, which results in the generation of warmer air with higher humidity than the initial ambient air.

The water extraction stage 14 includes a heat exchanger or absorber that cools the humid air stream manufactured in stage 12. The air stream is cooled to its dew point, thereby resulting in condensation of water vapor and production of liquid water. The condensed liquid water may be filtered and/or otherwise purified at stage 16 by any number of purification and/or filtration devices. Such devices may include a bacteriostat loop which serves to destroy adventitious living organisms, and filters which filter out undesirable contaminants. Filtration and/or purification systems used in stage 16 can be configured to reduce contaminants and VOC's to a level defined by National Science Foundation (NSF) Standard 53. A recirculation loop may also be provided to recirculate stored condensate during periods of inactivity.

The water dispensing stage 18 can include a plurality of storage tank systems to dispense water through spigots. Various components in the water dispensing stage can include quick-disconnect fittings to facilitate easy assembly and reconfiguration. Flexible tubing can also be used so that the water can be remotely dispensed, and so that a secondary water source, such as a municipal water supply, can be incorporated into the system 10.

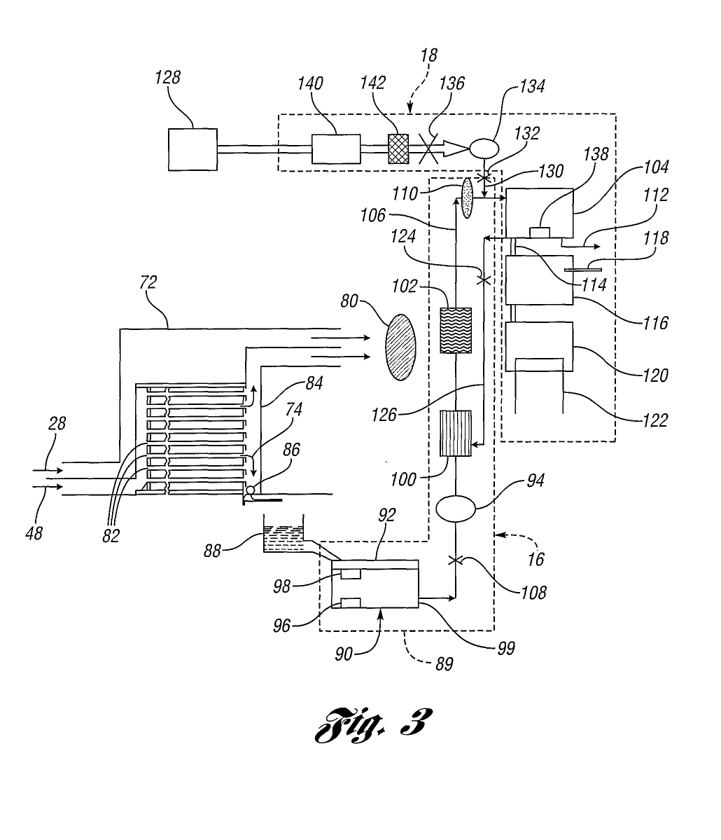

FIG. 2 shows the humid air manufacturing stage 12 and the water extraction stage 14 in detail. In the embodiment shown in FIG. 2, the humid air manufacturing stage 12 includes a first chamber, or collection chamber 20, and a second chamber, or regeneration chamber 22. The collection chamber 20 includes an inlet 24 and an outlet 26 which allow a first airflow 28 to flow through the collection chamber 20. As the air flows through the collection chamber 20, it is subjected to a first process which includes exposing it to a desiccant 30, which, in the embodiment shown in FIG. 2, is a liquid. The liquid desiccant 30 is sprayed into the first chamber 20 via a conduit 32.

As the first airflow 28 moves through the collection chamber 20, vaporized water is condensed out, and collects with the desiccant 30 in the bottom portion 34 of the chamber 20. The desiccant 30 is diluted as it adsorbs or absorbs the water from the first airflow 28. Although the desiccant 30 shown in FIG. 2 is liquid, the present invention contemplates the use of solid desiccants, or dual phase desiccants—e.g., solid and liquid. Any desiccant material effective to produce the desired result may be used, including solids, liquids, solutions, aqueous solutions, mixtures, and combinations thereof. Lithium chloride (LiCl) and calcium chloride (CaCl₂) are typical of liquid desiccant solutions, but other liquid desiccants may be employed.

Liquid desiccants such as polycols, alone or in mixture, may be used. Typical polycols include liquid compounds such as ethylene glycol, propylene glycol, butylene glycol, pentylene glycol, glycerol, trimethyol propane, diethytlene glycol, triethylene glycol, tetraethylene glycol, dipropylene glycol, tripropylene glycol, tetrapropylene glycol, and mixtures thereof. Polyol compounds which are normally solid, but which are substantially soluble in anhydrous liquid polyols or liquid hydroxyl amines, may also be used. Typical of these solid polyol compounds are erythritol, sorbitol, pentaerythritol and low molecular weight sugars. Typical hydroxyl amines include alkanolamines, such as monoethanol amine, diethanol amine, triethanol amine, isopropanol amine, including mono, di, and tri, isopropanol amine or digylcolamine.

Still other types of desiccants such as montmorillonite clay, silica gel, molecular sieves, CaO, CaSO₄ can all be used. As would be evident to persons of ordinary skill in the art, the selection of a desirable desiccant depends, among other parameters, upon the temperature and humidity ranges of ambient air from which moisture is to be absorbed. Still other exemplary desiccants comprise materials such as P₂O₅, BaO, Al₂O₃, NaOH sticks, KOH fused, CaBr₂, ZnCl₂, Ba(ClO₄)₂, ZnBr₂.

As noted above, the desiccant 30 is a liquid desiccant, which may comprise an aqueous solution of 40% lithium chloride. The desiccant 30 is pumped into the conduit 32 by a pump 36. The pump 36 pumps the desiccant 30 through a first heat exchanger 38 prior to its introduction into the collection chamber 20. By cooling the desiccant 30, its ability to remove water from the first airflow 28 is increased. A fluid, such as a refrigerant, is passed through the heat exchanger 38 via conduits 40, 42. The desiccant 30 is cooled in the heat exchanger 38 to a temperature below that of the first airflow 28. In this way, the airflow 28 is cooled as it passes through the collection chamber 20. As an alternative to the heat exchanger 38, a heat exchanger may be placed inside the collection chamber 20 to cool the first airflow 28 directly, or to cool the desiccant 30 after it is sprayed into the collection chamber 20.

The regeneration chamber 22 also includes an inlet 44 and an outlet 46, which facilitate movement of a second airflow 48 into and out of the regeneration chamber 22. In the embodiment shown in FIG. 1, the two chambers 20, 22 are conveniently disposed adjacent each other inside a housing 50. Between the two chambers 20, 22 is a partition 52, which allows the hydrous desiccant from the collection chamber 20 to mix with desiccant in the regeneration chamber 22, and vice versa. Instead of the partition 52, a valve or other flow control device may be used to control the flow of desiccant between the two chambers 20, 22. In the embodiment shown in FIG. 2, the partition 52 allows for equalization in concentration of the desiccant 30 which is achieved through osmotic flow. Thus, the desiccant 30 in the collection chamber 20 is not rapidly diluted and rendered ineffective. In addition, a float (not shown) may be employed to operate in an opening 54 just below the partition 52. The float can be used to help measure the temperature differential between the two chambers 20, 22, and to control the degree of sensible heat transfer. By modifying the size of the opening 54, via a float or some other structure, it is possible to influence the degree of sensible heat transfer and further optimize the system 10.

As with the collection chamber 20, the regeneration chamber 22 also includes a pump 56 which is used to pump the desiccant 30 into the regeneration chamber 22 through a conduit 58. The desiccant 30 is sprayed into the regeneration chamber 22 with an orientation that is generally perpendicular to at least a portion of the second airflow 48. This is similar to the arrangement in the collection chamber 20. By crossing the flow directions between the desiccant 30 and the first and second airflows 28, 48, contact between the air and the desiccant is increased, without generating the high pressure that might be associated with parallel flows.

As shown in FIG. 2, the desiccant 30 is pumped by the pump 56 through a second heat exchanger 60. Heat can be added to the heat exchanger 60 from any convenient source, via conduits 62, 64. By passing through the heat exchanger 60, the desiccant 30 is heated to a temperature above the temperature of the second airflow 48, so that the second airflow 48 is heated as it passes through the regeneration chamber 22. By heating the second airflow 48, more water is evaporated from the desiccant 30 into the second airflow 48. As an alternative to the heat exchanger 60, which is located outside the regeneration chamber 22, a heat exchanger 66, shown in phantom in FIG. 2, may be located inside the regeneration chamber 22. The heat exchanger 66 can be supplied with heat from any convenient source via conduits 68, 70.

In alternative embodiments, non-liquid desiccants can be used in a variety of configurations. In one example, a solid water absorbing material is used to absorb water from an incoming air stream and then subjected to a dry air stream that causes the transfer of water vapor from the solid water absorbing material to the dry air stream. The transfer may occur through a series of alternating cycling air streams, each of which may be warmed or cooled depending on what would best cause the transfer of water vapor. In another example, solid desiccants can be dispersed into an air trap that contacts incoming air streams. The desiccants absorb or adsorb water from the air. The trap is then exposed to a heating element, thereby causing the water to evaporate from the desiccant and regenerating the desiccant. The air containing the evaporated water is then exposed to a water extraction stage, as described below.

The humid air manufacturing stage 12 results in two separate airflows exiting the chambers 20, 22. The first airflow 28 of now dry air exits the collection chamber 20 through the outlet 26, and the second airflow 48 of now humid air exits the regeneration chamber 22 through the outlet 46. The water extraction stage 14 includes a system heat exchanger 72. In the embodiment shown in FIG. 2, the heat exchanger 72 is configured to receive the cool dry airflow 28 and the warm humid airflow 48, such that heat is transferred between the two airflows 28, 48. In particular, heat will be transferred from the warmer airflow 48 to the cooler airflow 28, resulting in extraction of water 74 from the second airflow 48. As an alternative to using the first airflow 28 to cool the second airflow 48, another source of cooling, such as a refrigerant, may be passed through the heat exchanger 72 via conduits 76, 78.

One of ordinary skill in the art would appreciate that the extraction of water from the first airflow 28 increases the latent heat of the desiccant 30, and results in latent cooling of the first airflow 28. Additionally, because the desiccant 30 (or alternatively the chamber 20, or both) is cooled, the first airflow 28 itself undergoes sensible cooling that lowers its temperature level, thereby creating cooled, dry air. In one embodiment, the present invention uses 10 liters of lithium chloride solution to extract 2 liters per hour of moisture from incoming air that is provided by an air blower rated at 250 m³/hour. The result is a sensible cooling capacity of 0.7 kW and a latent cooling capacity of 1.4 kW, thereby enabling a temperature reduction in the air of 8.4° C.

As shown in FIG. 3, the first and second airflows 28, 48 are pulled through the heat exchanger 72 (and respectively through the chambers 20, 22) by a fan 80. The heat exchanger 72 is a radiator-type heat exchanger which includes a plurality of air tubes 82 through which the airflow 48 passes. As heat is transferred from the airflow 48 to the airflow 28, water 74 condenses out of the airflow 48 and trickles down a header pipe 84. The water 74 actuates a float valve 86 which may be configured to work by its own buoyant power or by a sensor. The water 74 then drops into a condensate collector 88 after being released by the float valve 86.

Once the water is extracted from the airflow 48 and collected in the condensate collector 88, it can be subject to a variety of filtration, purification, storage, and dispensing steps. As shown in FIG. 3, the water leaving the heat exchanger 72 is then processed by a water treatment subsystem 89 at the water purification and filtration stage 16 and dispensed the water dispensing stage 18. The additional steps actually employed in these last two stages 16, 18 are dependent upon the type and nature of the application for which the water producing system 10 is being used. For example, in one embodiment, the water purification and filtration stage 16 uses ceramic filters to remove water born pathogens. In addition, the ceramic filters can be filled with a high-grade silver activated carbon.

Various grades of readily available activated carbons, such as Columbia, Pittsburgh, Barnebey-Cheney, Continental, Bone Char, Acticarbone, Cochranex, Carboraffin, by way of illustration and not limitation, can be used as the medium. Such carbons can be prepared from a variety of sources such as wood, bones, blood, carbohydrates, coal, coconut shells, corncobs and cornstalks, kelp, lignite, nutshells, oil shale, petroleum coke, rubber waste and sawdust. The activated carbon employed may be in various forms, for example it may be in granular, powdered or pelleted form or combined in preformed materials such as fibers, slurry, paper or other supporting media. Because of a high adsorption rate, granular carbons may be particularly effective. A mesh size of less than about 100 may be more effective than larger sizes, but larger sizes may be suitable where higher flow rates are desired.

In yet another alternative embodiment, a kinetic degradation fluxion (KDF) and carbon combination filter is used. This is similar to a granular activated carbon filter with additional metal removal capabilities, including lead. Chlorine is converted to chloride by the KDF portion, which is a zinc/copper composite. This extends the life of the carbon media bed. This type of filtration also helps to minimize biological activity. Additionally and/or alternatively, the present invention uses reverse osmosis, ion exchange demineralization, and/or ultra fine membrane filters as stand alone or in combinations.

Another embodiment of the present invention utilizes fabric filters having enhanced capabilities for removing contaminants from a fluid. The fabric filters utilized may be treated with an inorganic hydrolyzing composition such as sodium hydroxide. Such a filtration system, utilizing a cellulose acetate fiber filter, effectively removes microbiological flora. By utilizing such a system in conjunction with a virus filtration unit and a reverse osmosis membrane, a liquid such as water may be very highly purified. Media such as activated carbon, which are used for adsorbing viruses, are treated with inorganic sodium containing hydrolyzing composition.

It may be desirable, however, to use a filtration system that is easily maintained, where the filters can be regenerated, and where the filters can be used without requiring frequent replacements. Additionally, numerous other filters can be used at different stages in the process, including UV filters, sediment filters, pre-carbon filters, post-carbon filters, and ultrafiltration cartridges.

Referring back to FIG. 3, one embodiment of the present invention includes an ultraviolet light unit 90. The UV light unit 90 can be advantageously combined with a plurality of other filters to improve the quality of water. The UV unit 90 is designed so as to maximize the bacteria-killing effect of an optimal frequency of ultraviolet radiation. Accordingly, the interior surfaces of the unit 90 are coated with reflective material, and the unit 90 is shaped around a high-intensity, short wavelength ultraviolet lamp (not shown) so as to direct the liquid condensate into the optimum zone of bacteria destruction. The UV lamp may be changed by removal of the unit cap 92.

A pump 94, preferably self-priming, is activated according to the volume of water within the UV unit 90 by means of a lower sensor 96 and an upper sensor 98. The lower sensor 96 and upper sensor 98 are both electrically connected to a pump relay switch (not shown) that closes and allows power to the pump 94 when both the lower sensor 96 and the upper sensor 98 are immersed in water. The pump 94 provides pressure sufficient to pull water from the second end 99 of the UV unit 90, forcing water through a solid-core charcoal filter 100 and a mineralizing cartridge 102 into a storage tank system 104. The pump 94, solid-core charcoal filter 100, mineralizing cartridge 102 for adding minerals to the purified water, and the storage tank 104 fluidly communicate via a conduit 106. A check valve 108, placed serially with respect to the pump 94 and UV unit 90, prevents reversal of water flow when the pump 94 is deactivated.

To regulate the level of water in the storage tank 104, the cover of the storage tank 104 is provided with an overflow float switch that regulates the speed of, or disallows power to, the multi-speed fan 80, thereby stopping and/or reducing the rate of condensation at the dew-forming surfaces of the heat exchanger 72 when the water level reaches the cover of the tank 104. In an alternate embodiment, where a heat exchanger, such as the heat exchanger 72, is cooled using typical refrigerant-expansion coils, power may be switched off to the refrigerant compressor (not shown) when the level of the water in the storage tank 104 approaches the attached storage tank cover, thereby stopping water condensation.

In the embodiment shown in FIG. 3, the liquid condensate is additionally passed through an oxygenator 110 prior to introduction into the storage tank 104, in order to healthfully introduce oxygen into the water. This completes an initial, or first treatment of the water, which, as explained below, may be subject to a second and subsequent treatments by recirculation through at least a portion of the water treatment subsystem 89. A quick-disconnect tube 112 may additionally be attached to direct water from the storage tank 104 into external containers. In one embodiment these external containers are large cisterns to store water for industrial, agricultural or commercial consumption. The water collected in the external containers can be further treated through chemical disinfectants such as chlorine, bromine, iodine, potassium permanganate, cooper and silver ions, alkalis, acids and ozone or any other suitable chemical agent known to persons of ordinary skill in the art.

To make the system 10 more desirable for office or home use, the system 10 is optionally fitted with subsystems for producing water at three temperatures—i.e., hot, cold and ambient. In one embodiment, water from the storage tank 104 is allowed to gravity feed through a self-sealing gasket and through a tube 114 into a cold-water tank system 116. The water may then be chilled within the cold-water tank system 116 by a low-pressure evaporator refrigerant coil of a secondary heat absorber (not shown). Other heat absorber methods may alternatively be used to cool the water, such as Peltier-effect or chemical/magnetic cooling or any other effective method. The water may be further gravity dispensed outside by means of a spigot (not shown). Energy dissipation from cold-water tank 116 is decreased by insulation. Additionally, a securable tube 118 may be sealing connected to the cold-water tank 116 to permit direct introduction of medicines and/or vitamins into the cold-water tank 116.

Water from the cold-water tank 116 further flows by gravity into a hot water tank system 120. The water may then be heated within the hot water tank system 120 by a heating element 122. The water is dispensed by means of another childproof spigot (not shown). The temperature of both hot and cold water is optionally displayed on a display panel. In one embodiment, ambient temperature water is dispensed from the hot water tank 120 via a spigot (not shown) when the heating element 122 is not provided with electrical power. In an alternate embodiment, ambient temperature water is dispensed directly from the storage tank 104 via a separate spigot (not shown).

To maintain its purity and freshness, water in the storage tank 104 may be recirculated on a periodic basis through at least some of the water treatment subsystem 89. For example, water from the tank 104 may be recirculated through the UV unit 90; however, in the embodiment shown in FIG. 3, the water is only recirculated through the filter 100, the mineralizer 102, and the oxygenator 110. A solenoid valve 124, placed serially in fluid communication via conduit 126 between the storage tank 104 and the UV unit 90, prevents flow of water from the storage tank 104 to the UV unit 90 unless electrical power is supplied to the solenoid valve 124. This prevents water in the storage tank 104 from draining if electrical power to the apparatus fails. Recirculation of the condensate is accomplished by activating a recirculation pump (not shown) at predetermined time intervals. By this repeated process, water is intermittently and continually recirculated across portions of the water treatment subsystem 89 whenever the water producing system 10 is in use. The flow duration may be defined by the volume circulated or by time. An indicator port (not shown) on the exterior of the UV unit 90 may be used to confirm proper operation of the UV unit 90.

In one embodiment, water can be collected from any or all of the tanks 104, 116 and/or 120 in an external container (not shown) wherein cartridges of medicines and/or vitamins can be advantageously inserted. This arrangement keeps the medicated-vitamin-supplemented water mass from being recirculated through the UV bacteriostat zone.

In the embodiment shown in FIG. 3, an external, secondary source of water 128, such a municipal water supply, supplies water to the storage tank 104 in the event of low water level in the tank 104. Accordingly, conduit 106 is fitted with a tee 130 to permit fluid communication with the external water source 128. A solenoid valve 132 is provided to prevent water from flowing through the external water source side of the tee 130 unless activated by an actuating electric power signal. At the external water source side of the solenoid valve 132, a female quick-disconnect fitting (not shown) is provided to permit easy coupling and uncoupling of external water source 128. The externally supplied water is passed through the tee 130 in the direction of the storage tank 104. A check valve (not shown) can be used to prevent water from flowing toward the UV unit 90.

The externally supplied water may be directed through a reverse-osmosis membrane filter 134, which in turn, simultaneously directs filtered water into storage tank 104 and wastewater through drain outlet into a drain for disposal (not shown). A solenoid valve 136 prevents external water from entering the membrane filter 134, unless activated by electrical signals from a low water sensor 138 provided at the inside bottom of the storage tank 104. If there is low water in the storage tank 104, an electrical signal is either sent to the pump 94, or if the apparatus is connected to an external water source such as the water source 128, the signal is sent to the inlet water solenoid 136 to open it, thereby letting water pressurize the system. Optionally, a booster pump 140 is provided at the external water source end of the solenoid valve 136 to pump pressurized external water through a fluidly communicating sand/sediment filter and pre-filter 142, serially provided between the booster pump 140 and membrane filter 134, to remove heavy metals and VOC's from the external water.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for producing water, comprising:
removing water from a first airflow using a first process which includes exposing at least some of the first airflow to a desiccant, thereby increasing water content of at least some of the desiccant;
introducing at least some of the desiccant having increased water content into a second airflow, thereby facilitating evaporation of water from the desiccant into the second airflow and increasing water content of the second airflow; and
removing water from the second airflow after its water content is increased.

2. The method of claim 1, wherein the first process further includes cooling the first airflow to facilitate increased water removal from the first airflow.

3. The method of claim 2, further comprising cooling the desiccant to a temperature below the temperature of the first airflow, and wherein the first airflow is cooled by contact with the cooled desiccant.

4. The method of claim 1, further comprising heating the second airflow to facilitate increased water evaporation from the desiccant into the second airflow.

5. The method of claim 4, further comprising heating at least some of the desiccant to a temperature above the temperature of the second airflow after the desiccant is exposed to the first airflow, and wherein the second airflow is heated by contact with the heated desiccant.

6. The method of claim 1, wherein removing water from the second airflow includes cooling the second airflow, thereby facilitating condensation of water from the second airflow.

7. The method of claim 6, wherein cooling the second airflow includes transferring heat from the second airflow to the first airflow after water is removed from the first airflow.

8. The method of claim 1, further comprising providing a first treatment to the water removed from the second airflow, the first treatment including at least one of the following steps: exposing the water to ultraviolet light, passing the water through a charcoal filter, adding minerals to the water, or oxygenating the water.

9. The method of claim 8, further comprising:
storing at least some of the treated water; and
providing a second treatment to the stored water after a predetermined time has passed, the second treatment including at least one of the steps performed in the first treatment.

10. The method of claim 1, further comprising:
passing the first airflow through a first chamber where the first airflow is exposed to the desiccant, thereby removing water from the first airflow and increasing water content of the desiccant; and
passing the second airflow through a second chamber, and
wherein the at least some of the desiccant having increased water content is introduced into the second airflow in the second chamber, and removing water from the second airflow after its water content is increased includes passing the second airflow through a heat exchanger, thereby facilitating cooling of the second airflow and condensation of water therefrom.

11. The method of claim 10, further comprising passing a refrigerant through the heat exchanger, thereby facilitating heat transfer from the second airflow to the refrigerant.

12. The method of claim 10, further comprising moving at least some of the desiccant from the second chamber to the first chamber after at least some of the water has evaporated from the desiccant.

13. The method of claim 10, wherein the desiccant is at least partially liquid, and wherein introducing the desiccant into the second chamber includes spraying the desiccant into the second chamber generally perpendicular to at least a portion of the second airflow.

14. The method of claim 13, further comprising cooling the desiccant to a temperature below the temperature of the first airflow entering the first chamber, thereby cooling the first airflow as it passes through the first chamber, and increasing the amount of water removed from the first airflow.

15. The method of claim 14, further comprising passing the first airflow through the heat exchanger after water is removed from the first airflow, thereby facilitating heat transfer from second airflow to the first airflow.

16. A system for producing water comprising:
a first chamber having an inlet and an outlet for facilitating movement of a first airflow into and out of the first chamber;
a desiccant capable of being introduced into the first chamber for removing water from the first airflow moving through the first chamber;
a second chamber configured to receive at least a portion of the desiccant after it removes water from the first airflow, the second chamber including an inlet and an outlet for facilitating movement of a second airflow into and out of the second chamber, thereby facilitating evaporation of water from the desiccant in the second chamber into the second airflow; and
a system heat exchanger configured to receive the second airflow from the second chamber and to facilitate cooling of the second airflow to extract water therefrom.

17. The system of claim 16, further comprising a first heat exchanger configured to cool the desiccant before it is introduced into the first chamber.

18. The system of claim 16, further comprising a second heat exchanger configured to heat the desiccant before it is introduced into the second chamber.

19. The system of claim 16, wherein the system heat exchanger is further configured to receive the first airflow from the first chamber, thereby facilitating heat transfer from the second airflow to the first airflow.

20. The system of claim 16, further comprising a water treatment subsystem configured to treat the water extracted from the second airflow, the water treatment subsystem including at least one of an ultraviolet light source, a charcoal filter, a mineralizing source, or an oxygenator.

21. The system of claim 16, further comprising a plurality of storage tank systems configured to receive the water extracted from the second airflow, at least one of the tank systems being configured to heat or cool the water stored therein.

22. The system of claim 16, further comprising a secondary water source configured to facilitate combining water from a secondary water source with the water extracted from the second airflow.
